(19) United States
(12) Patent Application Publication
(10) Pub. No.: US 2006/0175445 A1
(43) Pub. Date: Aug. 10, 2006

(54) Self-propelled hydrostatic drive bale shredder for large bales

(75) Inventor: Russell J. Hoovestol, Jamestown, ND (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: DuraTech Industries, Jamestown, ND (US)

(21) Appl. No.: 11/054,248

(22) Filed: Feb. 9, 2005

(51) Int. Cl. B02C 19/00

(52) U.S. Cl. 241/101.74

(57) ABSTRACT

A self-propelled bale shredder is movable over the ground, and has a self-contained power unit, a shredder section, and an operator's control cab at the forward end. The shredder includes a shredding rotor that will shred baled crop material that is lifted onto a platform by a pivoting bale lift arm. The bale lift arm is adapted to lift both large round and large rectangular or square bales into position on a feeder to feed the bales against the rotor for shredding. The shredded material is fed into an impeller and projected through a discharge chute to a desired location. The self-propelled shredder is mounted on axles that can tilt to maintain the shredding section at a desired relationship to a horizontal plane when on side hills.

### BACKGROUND OF THE INVENTION

The present invention relates to a self-propelled shredder for lifting large round bales or large square bales of hay or other crop material and moving and supporting such bales for engagement with a shredding rotor. The self-propelled shredder has a frame that includes three sections, including a control section, a shredding section and a power source section. The shredded materials are fed to an impeller for discharge and may be used as feed or as a mulch. A bale lifter that will lift either large round or large square bales is provided.

Bale shredders are well known and generally have been units towed behind a tractor and powered with the tractor power takeoff. The prior art shredders generally discharge shredded crop material directly through a side outlet. The shredded material cannot easily be placed at locations spaced from the shredder. The present pull behind shredders do not compensate for side hills. Typical prior art shredders include those shown in U.S. Pat. Nos. 4,449,672 and 5,090,630.

### SUMMARY OF THE INVENTION

The present invention relates to a self-propelled bale shredder that includes a frame that is supported and driven with ground engaging wheels that can be steered. The frame supports three sections, a power unit, a feed and shredder rotor in the center, including a discharge unit, and a control console in an operator's cab.

Hydrostatic drive units are preferably used for driving the wheels and the various powered components are hydrostatically driven. Thus, the power source, as shown an internal combustion engine, that is provided, drives suitable hydraulic pumps, that provide the hydraulic fluid under pressure.

The shredder frame has axles that are adjustable in with hydraulic cylinders and also are adjustable about a horizontal fore and aft axis to permit tilting the axles. The operating cylinders to tilt the axles on opposite sides permits compensating for side hill operation, so that the shredder rotor and bale feeder are maintained substantially level and will continue to shred bales on the feeder as the machine is moving along a side hill.

The controls are in a cluster adjacent to an operator in a cab. The controls include a joystick and operate switches that in turn operate hydraulic valves to drive motors and hydraulic cylinders. The functions controlled can also be monitored in several different ways, including digital or analog sensors that sense loading, position, speed and other feedback signals of the various components.

Since the present shredder will process both large square bales or the large round bales, a powered bale lifter that will handle both types of bales is used in connection with the shredder. The bale lifter includes fork members or tines that will slide under the curved bale surface portions of a round bale resting on the ground. The bale lifter is power-operated so that one of the fork tines can be moved laterally relative to the other to form a “grip” or squeeze. The fork tines are positioned on opposite sides of a square cross section bale, and then the tines are moved together to squeeze the square bale and hold it securely while it is lifted from the ground onto the feeder for the shredder rotor.

The shredder rotor is a known rotor that has flails that will extend through bale support bars. The bale support bars are adjustable so that they can be moved away from the rotor axis a selected distance to prevent the rotor from being overloaded and “slugging”.

The shredded crop material is deposited in a trough below the rotor, and an auger is used to convey the shredded material to a rotating impeller or blower, that discharges the shredded material out through a discharge chute laterally of the machine. The discharge chute, as shown, is adjustable about an upright axis so that it can be used to discharge material at different locations. The discharge chute has a substantial lateral reach to blow the shredded material some distance from the side of the self-propelled shredder. The impeller discharge chute also can discharge into a truck or hopper box.

The bale lift fork or arm is double jointed, or in other words has two sections including a base bale lift section that is pivoted to the shredder frame at a first end, as a second section having one end pivoted to a second end of the base section. The bale fork is pivoted to an outer end of the second section. The two lift arm sections can be pivoted with hydraulic cylinders to accommodate transferring most types of bales from the ground to the bale feeder and support.

The hydrostatic four wheel ground drive has three different speed ranges, and provides an infinite speed selection between zero and preferably about twenty miles per hour. The axles are extendable and retractable and will telescope out to about an 11 foot wide tread. The axles will retract to allow for legal transportation on North American highways. The bale feeder conveyer speed, the discharge blower speed, and the rotor speed are all adjustable from the operator station, for consistent mulch processing. The operator station or cab is fully enclosed and climate controlled.

### BRIEF DESCRIPTION OF THE DRAWINGS

FIG. 1 is a side elevational view of a self-propelled shredder made according to the present invention;

FIG. 2 is a front elevational view of the self propelled shredder of FIG. 1 with the front axle tilted and with parts broken away;

FIG. 3 is a top plan view of the self propelled shredder;

FIG. 4 is a schematic perspective view of the shredder showing a bale lift fork holding a round bale in position, and also showing a round bale in position on the feeder platform;

FIG. 5 is a view similar to FIG. 4 with a single bale about to be rolled onto the bale feeder platform;

FIG. 6 is a side perspective view of the side of the shredder shown in FIG. 1;

FIG. 7 is a side elevational view of the shredder of an opposite side from FIG. 6, with the bale lifting fork fully raised;

FIG. 8 is a fragmentary top view of the bale support bars and shredder rotor, with parts broken away;

FIG. 9 is a view taken generally along line 9-9 in FIG. 8 illustrating an adjustment for support bars for the bale that is being shredded;

FIG. 10 is a front view of the bale lifting fork;

FIG. 11 is a sectional view taken on line 11-11 in FIG. 10.

FIG. 12 is a bottom perspective view of the bale lifting fork;

FIG. 13 is a top plan view of the bale lifting fork with a square bale shown in the fork;

FIG. 14 is a rear view of the rear axle extending with the axle retracted relative to the frame of the bale shredder;

FIG. 15 is a rear perspective view of the rear axle with the axle fully retracted;

FIG. 16 is a rear perspective view of the rear axle inclined for side hill operation and with the axles extended;

FIG. 17 is a front perspective view of the front axle extended and inclined for side hill operation;

FIG. 18 is a perspective view of a control station for the self-propelled bale shredder; and

FIG. 19 is a block diagram of the control and functions of the self-propelled baler.

### DETAILED DESCRIPTION OF THE PREFERRED EMBODIMENTS

A self-propelled bale shredder indicated generally at 10, as shown has a frame 12 that supports a front cross axle 14 and a rear cross axle 16 that are each pivotally mounted to the frame 12 about a common fore and aft or longitudinal axis on pivots mounted on cross members 17 and 19 with bearing supports 18 and 20. The cross members extend between longitudinal frame members 12A.

The front wheel assemblies 14A and rear wheel assemblies 16A are individually driven, with hydrostatic motors 46, one for each wheel. The front axle 14 is free to pivot about pivot pin 18A. The position of the rear 16 relative to the plane, the frame 12 about the axis of the pivot pin 20A is controlled by hydraulic actuators, the hydraulic actuators 24 for the rear axle. The 24 are electric over hydraulic controlled, double-acting actuators that can be extended and retracted to control the tilt of the rear axle relative to the plane of the frame 12. The front axle 14 will follow the terrain and permit the tilt of the frame to be controlled by the rear axle position.

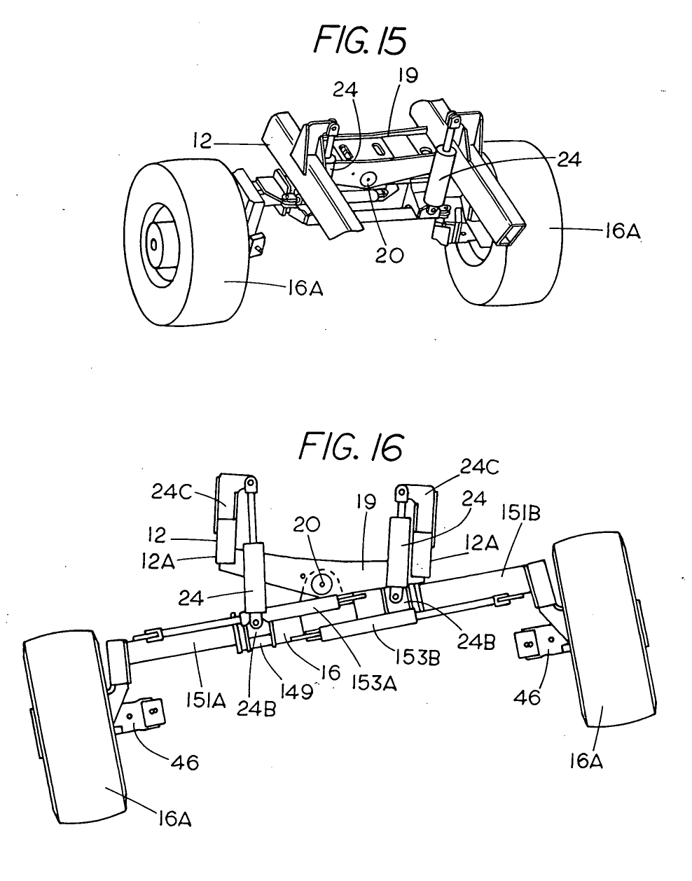

The axle tilt hydraulic actuator is operated in a suitable manner, usually automatically, in response to level sensor signals from a level sensor, which is shown schematically at 21B for the rear portion of the frame and rear axle. The tilt sensor will indicate when the plane of the frame 12 is not transversely level, to compensate for side hill operations. The actuator 24 also can have sensors that sense the amount of extension of the actuator rods to provide signals that keep the rear axle at a proper position. The construction of the axles and mounting are shown in more detail in FIGS. 14-17.

The self-propelled shredder 10 is made up of three sections, including an engine or power source section 28 at the rear of frame 12, a bale handling, feeding and shredding section 30 that is in the mid portions of the frame 12 as shown in FIG. 1, and a control cab 32 at the forward end of frame 12. The control cab 32 is the control center for the shredder, and has an operator station for operating all of the controls.

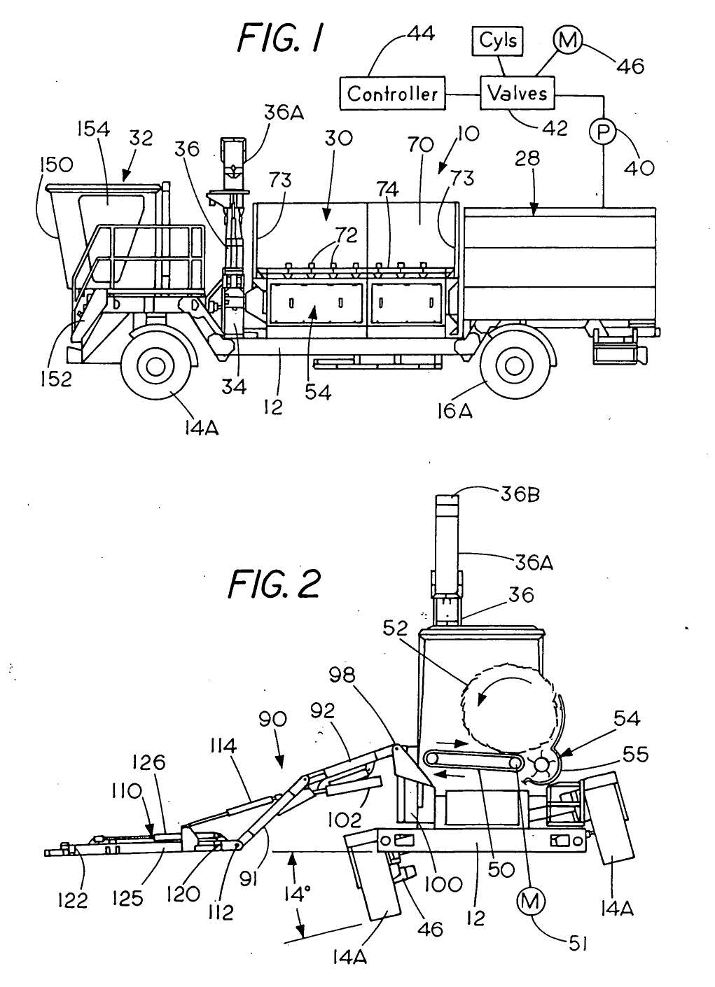

A centrifugal blower or impeller 34 is mounted on the frame as part of the shredder section 30 and receives material that has been shredded. The blower will discharge the shredded out through a suitable discharge chute 36 in a normal manner. Chute 36 can be rotated about an upright axis, and also folded downwardly so it will nest along one side of the frame 12. Its operative position is shown in FIG. 2, but the chute can be folded for transport. The chute 36 can discharge shredded material onto the ground, or can discharge into a truck or trailer box moving with the bale shredder.

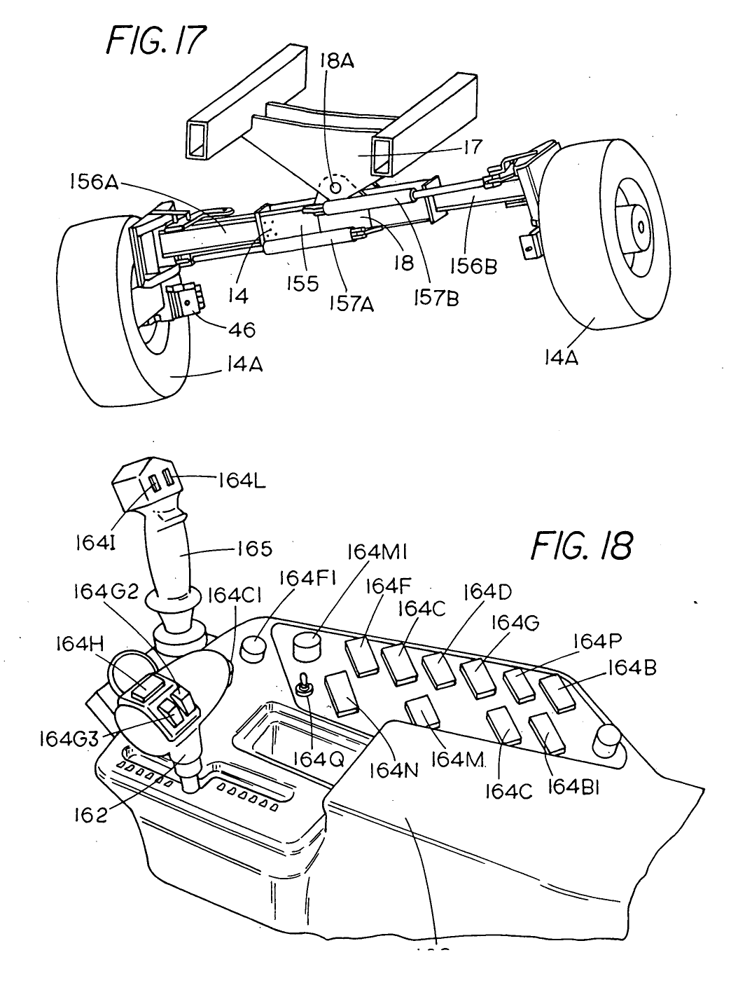

The power source or engine section 28 houses an internal combustion engine that can be of any selected horsepower, but is generally a high horsepower industrial engine, and it is used for powering suitable hydraulic pumps illustrated schematically at 40, that will operate through suitable valves 42, controlled by a controller 44. Controller 34 can be a manual controller, or an automatic controller operable in response to sensor signals or other parameters that are provided or a combination, where some motors are automatically controlled or controlled by a program, while others are manual. The controller 44 has control circuitry responsive to a joy stick position to provide pump control signals for hydrostatic pump and motor units represented at 46, that can be used for driving the individual wheel assemblies. There would be four hydrostatic drive units 46 for powering the individual wheels separately, under a central control. The swash plate hydrostatic pump and motor combinations 46 are well known drives used in many work vehicles. Rotational speed and direction is controlled by the operator adjusting the pump lever using a joystick 162 to provide signals. The hydrostatic motors are plumbed so that there is a differential action for the wheels when the vehicle is turned. The internal combustion engine speed can be set separately as shown schematically in FIG. 18, and also a drive range for the hydrostatic motors can be selected.

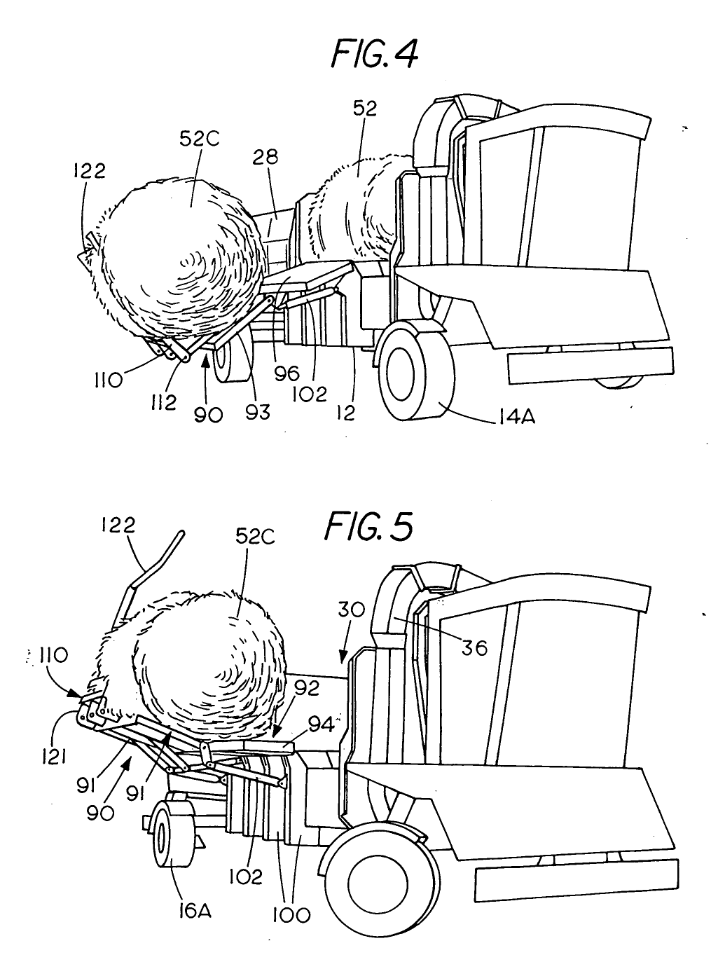

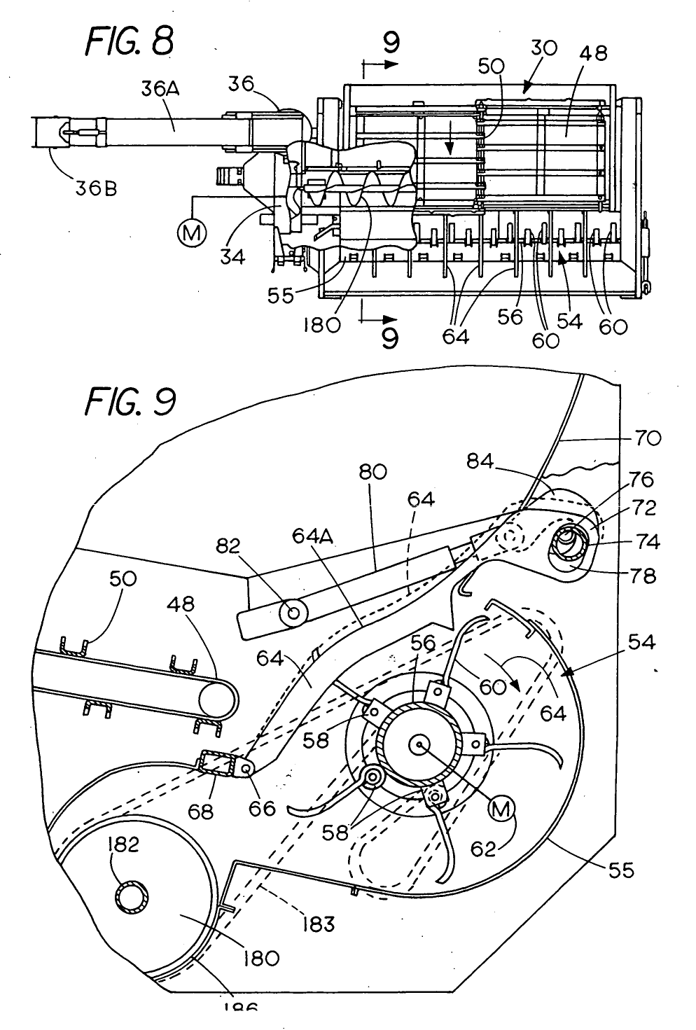

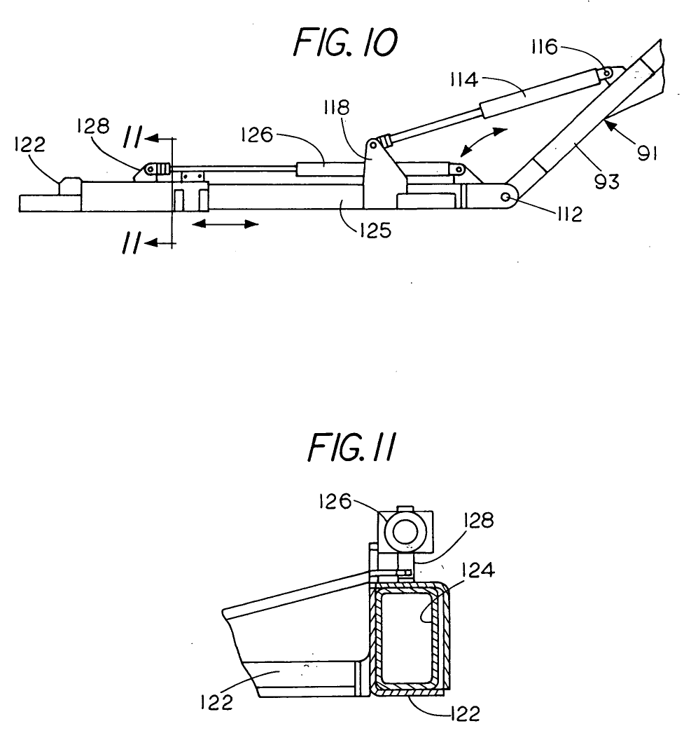

As shown schematically in the breakaway portions of FIGS. 8 and 9, the shredder section 30 includes a bale support and feeder platform 48, that has a feeder conveyer 50 mounted thereon and suitably driven with a hydrostatic motor 51, substantially as shown in U.S. Pat. No. 4,449,672, to move a bale illustrated schematically at 52 in FIGS. 2 and 4. The bale 52 feeder on the platform 48 is moved toward a shredding rotor illustrated generally at 54 in FIGS. 8 and 9. The shredding rotor 54 is also constructed essentially as shown in U.S. Pat. No. 4,449,672 and is shown in more detail in FIG. 9. The rotor 54 has a central shaft 56 that supports suitable radially extending ears 58 on which bale shredding flails 60 are pivotally mounted. The rotor 54 is mounted in an outer housing 55 that partially surrounds the rotor.

A hydraulic motor 62 may be for driving the central shaft 56, which is suitably mounted on bearings on the frame 12 and rotates in a direction indicated by the arrow 64 in FIG. 9. The outer ends of the flails 66 are hooked slightly, and will extend outwardly when the rotor is being rotated, to shred a bale 52 which is resting against a plurality of bale support bars 64 that are mounted onto and supported by the frame 12, using suitable supports.

As shown in FIG. 9, the bale support bars 64 are shaped and positioned so that they are between the flails 60 of the rotor 54 when the rotor is being rotated. The bale support bars 64 are pivotally mounted as at 66 to a frame member 68. The opposite ends of the bale support bars 64 extend outwardly through slots in a side wall 70 of the bale chamber or housing 55. The bale support bars 64 have outer end cam followers 72 thereon. A cam tube 74 passes through provided cam slots 78 in each of the cam followers 72. The cam tube 72 is rotatably mounted about an axis 76, on upright frame members 73 (FIG. 6). The axis 76 is off-center from the center axis of the cam tube 74 so that rotating the cam tube 74 causes the cam follower end to move and the bale support bars 64 to pivot about their pivot mounting 66. The bale support bars thus move relative to the rotor 54 so the spacing of a bale surface can be changed relative to the rotor.

In FIG. 9, the bale support bars 64 are shown in solid lines in a lowered position where the upper edge 64A of each of the bale support bars 64 is well within the circle formed by the periphery of the extended flails 60 when the rotor 54 is rotating. This means that an outer portion of a bale supported on the bale support bars 62 will be engaged by the flails and thus shredded.

The cam tube 74 can be moved about its axis 76 with a hydraulic actuator 80. The hydraulic actuator 80 has a base end 82 connected to the shredder frame 12, and has an extendable and retractable rod with a rod end connected to a lever 84 that is fixed to the cam tube 74. The hydraulic cylinder 80 will rotate the cam tube 74 about the cam tube pivot axis 76 when the actuator is extended or retracted. When the actuator is extended, it will raise the bale support bars 64 to the dotted line position shown in FIG. 9. The bale support bars 64 will lift the bale that is being shredded in a direction away from the rotor flails, so a more shallow cut will be made by the flails.

Moving the support bars 64 and lifting (or lowering) the bale can be done in response to a signal indicating that the drive engine is being excessively loaded, or by sensing the pressure in the line to hydraulic motor 62 that is driving the rotor 54, to reduce the load on the rotor and prevent the rotor from plugging or slugging completely. The support bars also can be moved so more of the bale is engaged by the flails.

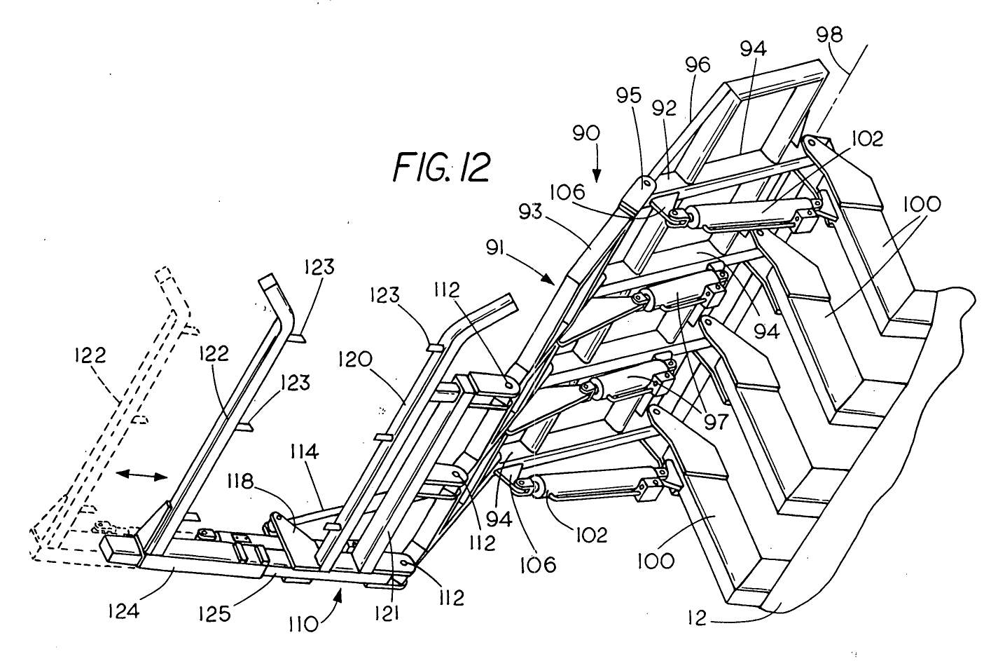

The cam tube 74 can also be seen (in FIG. 6). It extends through openings in the cam ends 72 of all of the bale support bars 64. Upper part 70 of the bale chamber wall 55 is shown in FIG. 11 as well.

As stated, rotating the cam tube 74 will shift the end portions 72 of the bale support bars 64 to move them radially inwardly and outwardly relative to the central shaft 56 of the rotor 54. The flails 60 of the rotor 54 will shred either a round bale or a square cross section bale. The flails 60 wear away the bale and the feeder conveyor 50 will keep moving the lower side of the bale toward the support bars 60. The bales will rotate or tumble as they are shredded to insure that the entire bale is shredded.

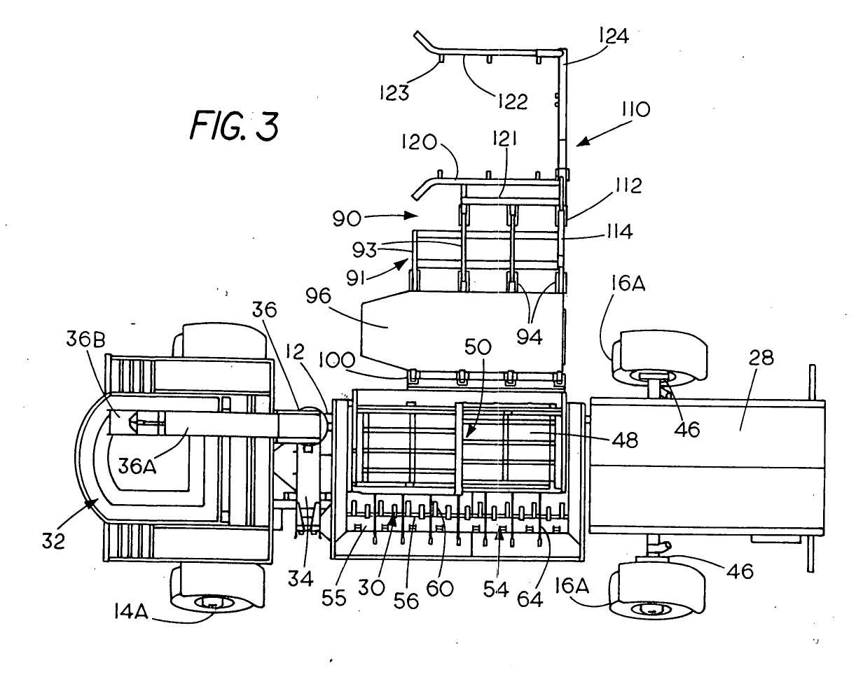

In order to move either a square bale or a round bale into the bale chamber, and along the feeder platform 48, a bale lift fork assembly 90 is used. This is shown best in FIGS. 3, and 10-13.

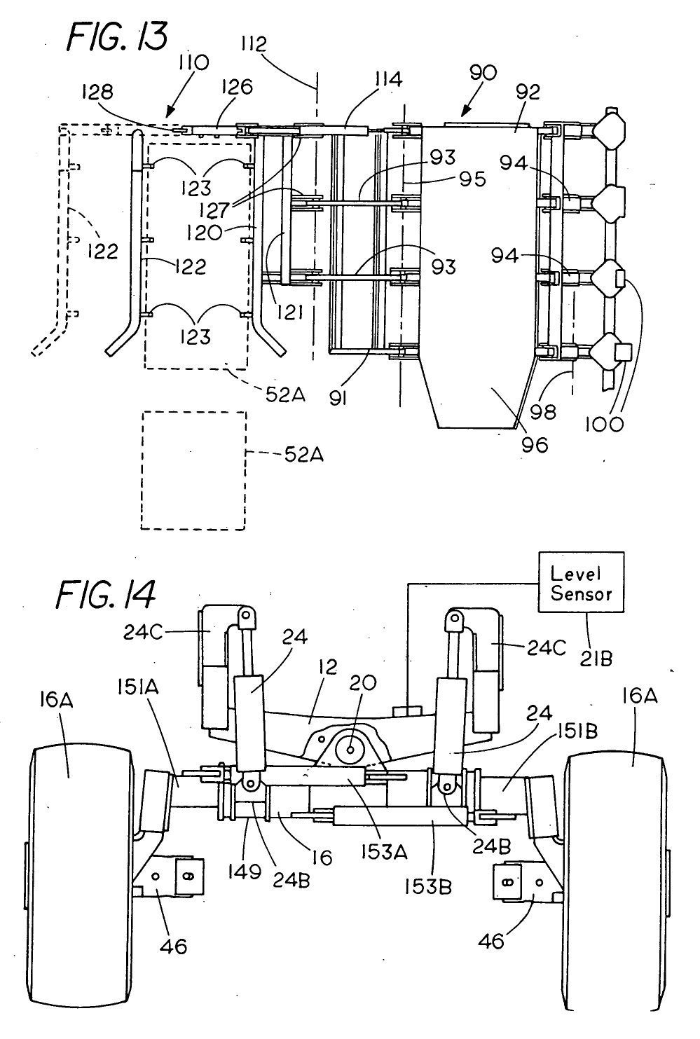

The bale lift fork assembly 90 is a multiple arm jointed bale lift arm, that has a base bale lift arm section 92 made up of a plurality of parallel base arms 94 that are illustrated in FIGS. 12 and 13. The base bale lift arm section 92 supports a slide platform or plate 96. The base lift arms 94 have ends pivotally mounted on pivots for pivoting about an axis 98. The arms 94 are pivoted on suitable supports 100 on the frame 12 at the center shredder section 30. The base bale lift arm section 92 of the bale lift arm assembly is moved about the pivot axis 98 through the use of hydraulic cylinders 102, one of which is under each of the outer arms 94, as can be seen in FIG. 12.

The actuators 102 have extendable and retractable rods, and have base ends that are mounted to brackets on upright frame members 100. The bases of the hydraulic actuators 102 are spaced downwardly from the pivot axis 98, so that there is a moment that can be generated to pivot the base bale lift section about the pivot axis 98.

The outer ends of the rods of the actuators 102 are connected to brackets 106 under the outer arms 94 and the extending and retracting of the rods causes the pivoting of the base bale lift arm section and thus the outer bale lift arm sections attached to the base bale lift section.

The base section arms 94 have a second bale lift arm section 91 pivoted thereto at pivots 95. Second or intermediate bale lift arm section 91 has lift arms 93 extending outwardly from the base arm section 92. The lift arms 93 are moved about pivots 95 by actuators 97 that have base ends connected to the two interior base bale lift arm section arms 94, and rod ends connected to brackets on the second or intermediate bale lift arm section 91. Thus, the base bale lift arm section 92 carries the second bale lift arm section 91 when the base bale lift arm section 92 is pivoted, and the second or intermediate bale lift arm section 91 can be independently pivoted relative to the base bale lift arm section 92.

The second bale lift arm section 91 has a bale lift fork 110 pivoted to the outer ends of the arms 93 at pivots 112. As can be seen in FIGS. 3 and 13, the bale lift fork 110 is supported on three of the arms 93 of the second bale arm lift section 91. The arms 93 extend downwardly and outwardly from the base bale lift arm section 94. The pivot axis for the bale lift fork 110 is parallel to the pivot axis 98 and the axis of pivots 95.

The pivotal movement of the bale lift fork 110 about axis of pivot 112 is controlled with a hydraulic actuator 114 that has its base end mounted on the second or intermediate bale lift arm section 91 as at 116, and the rod end of actuator 114 is connected to a bracket 118 fixed to an inner end tube 125 of the bale lift fork 110. When the cylinder or actuator 114 is extended and retracted, the bale fork 110 will pivot about the axis of pivots 112 relative to the second bale lift arm section 91 and also relative to the base bale lift arm section 92 of the bale lift arm assembly 90.

Bale lift fork 110 has a fore and aft extending fork tine 122. A tine 120 has an end fixed on the end tube 125 and the tine 120 is also fixed to the inner edge flange portion 121 of the bale lift fork 110 adjacent the pivot brackets and arms 93 at pivots 112. However, the outer fork tine 122 is mounted on an outer telescoping frame tube member 124 that telescopes into the inner end frame tube 125 on which tine 120 is fixed. The tube 124 can be moved inwardly and outwardly a selected amount to move tine 122 relative to the tine 120 with a hydraulic actuator 126, shown in FIG. 13. Actuator 126 has its base connected to a bracket on the frame portion 121, and its rod end is connected to a bracket 128 that is on the outer telescoping tube member 124 supporting the outer fork tine 124.

As shown in FIG. 13 in particular, a large square cross section bale of crop material, or other rectangular cross section bale 52A, can be picked up with the lift fork 110 by extending the tine 122 to its outer dotted line position, using the actuator 126. The shredder vehicle is moved to slide the fork tines on opposite sides of the square bale to be picked up with the tines raised upwardly from the ground. The outer fork tine 122 is then moved inwardly to clamp the square bale 52A against the inner, fixed tine 120. In a raised position, the fork tines grip the bale in mid-portions. This raised position of the bale fork is shown in FIG. 2, in conjunction with the side hill illustration.

The tines 120 and 122 optionally can have spikes or projections 123 thereon facing toward the space between the tines. When the outer tine 122 is moved to squeeze the square bale, the spikes will help in holding the bale securely.

When picking up round bales, the tines are kept close to the ground and spaced to slide under the sides of the bale, but spaced less than the diameter of the bale. The tines can lift the round bale without squeezing it. Also, as can be seen in FIG. 4, one bale 52 can be on the platform 48 and being shredded, while a second bale 52C is held on the bale lift arm assembly, and the lift can be raised to the position of FIG. 5 to move the bale 52C onto the platform 48 where it is moved to position to be engaged by rotor 54. The bale lift arm assembly then can pick up another bale.

Again, referring to FIG. 2, 15 and 16, the axles are shown tilted at approximately 14° from a horizontal position, to accomplish leveling of the frame 12 and the bale feeder platform relative to a horizontal plane when on a side hill to ensure that the movement of the bale into the shredding rotor is not affected by the side hill slope in one way or another. Steep side hills could cause the bale to tend to move away from the shredder rotor, thereby compromising the quality and speed of the shredding.

Suitable level sensors can be utilized on the frame 12, when the sensor indicates that the frame 12 is not level, the actuators 24 are operated to pivot the axles about the axis 20. The movement is to level the plane of the frame 12 and thus orient the bale conveyor and rotor properly.

FIGS. 15, 16 and 17, illustrate the front and rear axles that are extendable in lateral width, and can be extended when operating in fields as desired. As shown, the rear axle 16 includes a center tubular portion 149. Portion 149 is a rectangular tube or square tube that has a pair of telescoping smaller size tubes 151A and 151B, respectively that will slide in and out of the center tubular portion 149. The telescoping is controlled by a hydraulic actuators 153A and 153B, that have base ends attached to brackets on the center tubular portion 149, and have rod ends attached to brackets on the telescoping tube members 151A and 151B.

The actuators 24 for the rear axle have base ends mounted to the center tubular portion 149 with brackets 24B on pins, and the rod ends are pinned to uprights 24C that extend up from the frame fore and aft extending members 12A.

Upon operating the axle extending cylinders, the axle, as shown in detail the rear axle, can be extended from the retracted position shown in FIG. 14, to the extended position shown in FIG. 16. In FIG. 14, the rear axle is shown with the telescoping tube members 151A and 151B moved inwardly, to reduce the tread or transverse width of the wheels.

Generally the axle extending actuators 153A and 153B are operated in parallel, but individual operation could be possible so that the wheels could be extended on one side of the frame more than at the other side, if conditions made this desirable.

The front axle is shown in FIG. 17, in its extended position, and there a center axle section, which is a large size square tube 155 of size to receive telescoping square tube axle sections 156A and 156B, which are controlled for in and out movement with actuators 157A and 157B, respectively. The operation of the actuators 157A and 157B will move the axle sections 156A and 156B from extended to retracted positions. The positions of the front and rear axles can be different if desired for any particular reason. One side of the front axle can be extended more than the other if desired, or the axles can be extended equal distances from the center line of the frame.

The operator's compartment 32 has an outer cab 150 with suitable steps 152 to provide access through a door 154. An operator's seat is provided, and a console indicated generally at 160 is positioned adjacent the operator's seat. The console includes a joystick control 162 that is used for controlling fore and aft movement and speed by controlling the individual hydrostatic drive motors 46 on wheels 14A and 16A. Steering is achieved by suitable power steering cylinders controlled by a rotary valve controller driven by a steering wheel in a conventional manner. Since the wheels are independently driven, there is no need for providing any special linkages or mechanical drives, and suitable hydraulic lines can be used for connecting the drive wheel motors. The steering control can be as desired, and preferably can be two cylinders connected in series with internal rephasing reliefs. The steering cylinders can be arranged so telescoping steering linkage is not needed.

The swiveling of the discharge chute 36 is operated with hydraulic motors in a normal manner as well, and controlled by a switch 164H. The folding of the chute 36 can be controlled with a hydraulic cylinder 37.

Various other switches are located right at the console for operating the various components as needed.

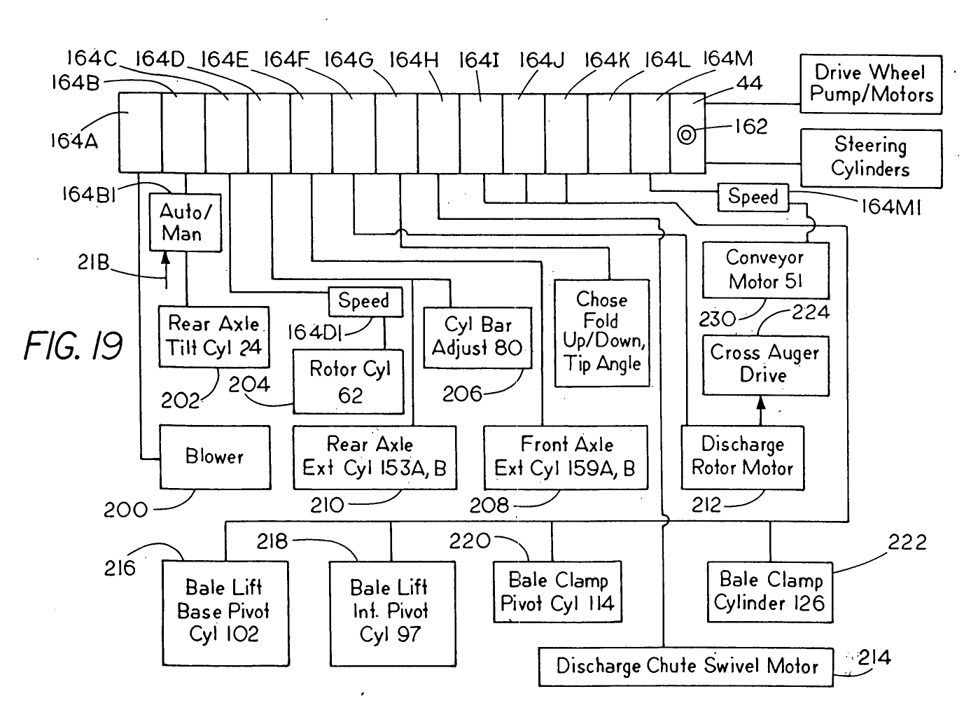

FIG. 19 is a block diagram representing the various components in the controlling switches that are also illustrated in the console.

The switches can be selected to be proportional, if desired, to control not only the direction of the operated component, but also the speed of movement. This is important in connection with motors for the shredding rotor 54, and the motor for the discharge impeller that discharges the shredded material from the unit.

The switches are shown only schematically, and can be any desired type. The joystick 162 is shown in FIG. 19 as well.

The rear axle tilt cylinder 24 shown at block 202 can be selectively set for automatic or manual operation with a selector switch 164B1. When set for manual operation, the cylinders are controlled from a manual switch 164B. The cylinders on opposite sides of the frame are operated so when one extends, the other retractors.

These switches permit manual operation of the rear axle tilt cylinder, as well as operation in response to a level sensor.

The shredding rotor or flail drive motor 62 is shown at block 20 is on and off controllable with a switch 164C and a control to regulate the speed of the motor is shown at 164C so that the rotational speed of the shredder or flail rotor can be controlled.

Additionally, the adjustment for the bale support or slug bars 64 which are operated by cylinder 80 is shown in block 206, and this can be controlled by a variable switch 164D.

The front axle extension cylinders 157A and 157B are represented by block 208, and the rear axle extension cylinders are represented by block 210. The cylinders can be operated from a single switch 164E to extend or retract the cylinders on both the front and rear axles in parallel. If desired, separate switches can be used to control the extension and retraction of the front and rear axles individually.

The discharge impeller or blower drive motor is represented at block 212, and is controlled for on and off operation by a switch 164F. The blower speed can be controlled from a rotary switch 164F1 shown only in FIG. 18.

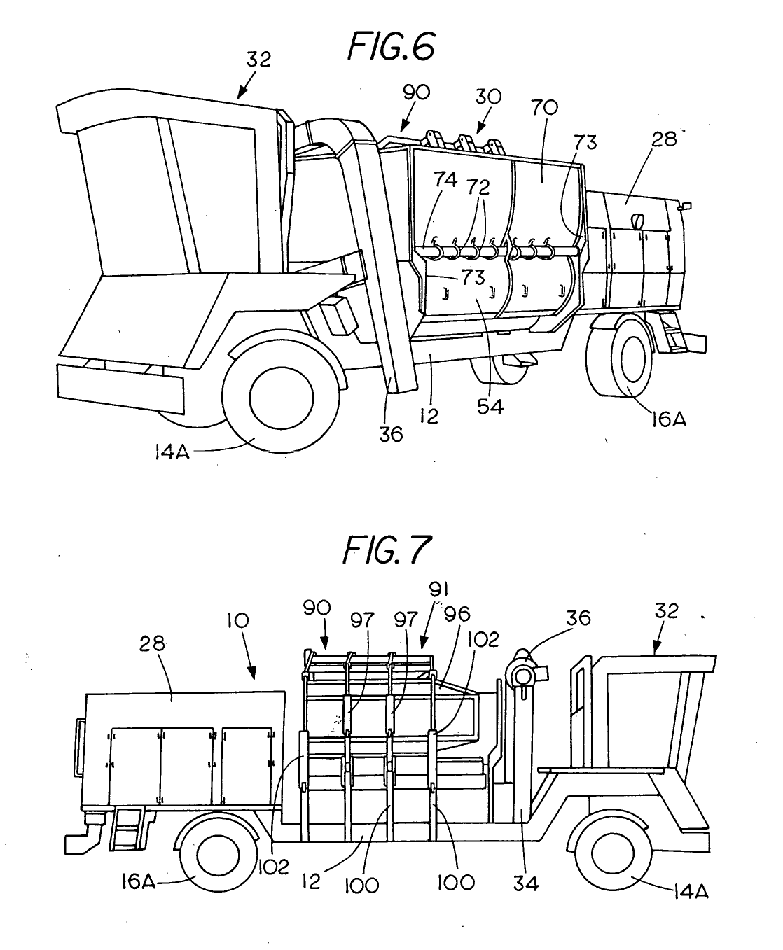

The discharge chute 36 also has a cylinder to fold it as shown in FIGS. 6 and 7, to move the outer section 36A up and down and a control to adjust the top deflector 36B. These cylinders are represented as a group at block 213 and controlled by a switch 164G. In FIG. 18, these switches are individually labeled as 164G1, 164G2, and 164G3.

The discharge chute swivel cylinder or drive motor, represented as a block 214, is operated with a switch 164H.

The bale lift or loader cylinders, are individually operable. The base bale lift section pivot cylinder 102, which controls pivoting of the bale lift relative to the vehicle frame is represented at the block 216 and is controlled with a switch 164I. The intermediate or second bale lift section cylinder 97 is represented at block 218 and is controlled with a switch 164J. These switches are incorporated in a loader control pivoting stick or lever 165 shown in FIG. 18. The bale clamp or fork tilt cylinder 114 which controls pivoting of the bale clamp or fork relative to the second bale lift section 91 is controlled with a switch 164K on lever 165, and is represented at block 220. The bale clamp cylinder 126 is represented at block 222 and is controlled by switch 164L, also on lever 165.

The single line representation from the switches 164I-164L in FIG. 19 is for convenience, but each switch controls the respective flow of hydraulic fluid to its controlled cylinder individually. The valves used for the cylinders can be solenoid operated or proportional flow valves as desired.

It should be noted that the drive for cross auger 180 represented at block 224 can be from the shredder rotor motor, and or the auger 180 can be driven by a separate motor controller from the controller 44 through a suitable switch, if desired.

The drive motor 51 for the conveyor 50 is represented at block 230 in FIG. 19 and is on/off controlled by a switch 164M. Speed control is provided by a variable control 164M1. FIG. 19 is a schematic representation only. In FIG. 18, these switches are labeled. In addition, FIG. 18 illustrates the internal combustion engine speed control or throttle 164N, and the ground drive speed range control is illustrated at 164P. A parking brake switch 164Q is also shown in FIG. 18.

Thus, the various drive functions can be controlled in a normal manner, to accommodate the use of a self-propelled bale shredder that will handle both square and round large bales, shred them, and direct the shredded material into an impeller that in turn will direct it to a desired location. The ability to extend the axles to be 11 feet wide for operation on side hills and the like is a substantial advantage and yet they can retract to be within the legal width for road travel.

The three section bale loader, with two sections or arms that are pivoted relative to each other, and relative to the frame, together with the pivoting of the bale fork itself, and the bale clamp mechanism insures that handling bales of various size and shapes is easily accommodated.

Further, the ability to limit the feed using a simple shredding bale support adjustment, such as that represented at 206 using a cylinder 80, and a pivoting a cam-type operator ensures adequate control to prevent “slugging” of the machine.

Cross auger 180, which is shown in FIG. 9 conveys the shredded crop material from the rotor to the discharge impeller housing. The auger 180 is a helical auger assembly of conventional design, which has a central shaft 182 that can be driven with a belt or chain drive from the shredding motor shaft as shown in dotted lines at 183. If desired, a separate hydraulic motor can be used to drive the shaft 182. The auger 180 conveys the shredded material from the rotor 54 laterally over to an inlet side of the impeller 34, and the impeller then discharges the shredded material through the chute 36.

The auger 180 is mounted in a suitable housing 186 that is generally parallel to the axis of rotation of the shredding rotor 52. The bales shredded are usually of crop material, such as hay or straw, but can be made of any desired material.

Although the present invention has been described with reference to preferred embodiments, workers skilled in the art will recognize that changes may be made in form and detail without departing from the spirit and scope of the invention.

What is claimed is:

1. A self-propelled shredder for shredding material from a bale, said shredder comprising a prime mover having a support frame, propulsion drives for ground engaging members to move the support frame along a ground surface, the self-propelled shredder comprising a first section at a rear thereof mounting an internal combustion power source, a second shredder section supporting a shredder assembly and having a bale loading assembly for lifting and loading bales into a feeder for a shredder rotor, and a third forward section comprising a control center for supporting an operator controlling the second shredder section, the first, second and third sections being supported on the same support frame and moved by the ground engaging members.

2. The self-propelled shredder of claim 1 wherein said second shredder section comprises a shredder rotor adjacent a lateral side of the support frame and rotatable about an axis extending in fore and aft directions, a feeder including a platform for supporting a bale for feeding a bale of crop material to the shredder rotor, and a plurality of support bars for supporting the bale of crop material at a desired location relative to a periphery of the shredder rotor when the shredder rotor is rotating, said support bars having first ends pivotally mounted with respect to the support frame, and second ends adjustably mounted for movement about the pivot to move the support bars toward and away from an axis of rotation of the shredder rotor to control the amount of crop material engaged by the shredder rotor when a bale is supported on the support bars.

3. The self-propelled shredder of claim 2, and a lifting fork pivotally mounted along an opposite lateral side of the frame from the shredder rotor, and wherein the lifting fork has arms extending outwardly from the opposite lateral side, the arms adjacent the support frame having a panel for slidably supporting a bale thereon.

4. The self-propelled shredder of claim 3, wherein said lifting fork comprises a multiple section lift arm assembly, a first arm section pivotally mounted to the support frame about a first pivot axis generally parallel to the axis of rotation of the shredder rotor, and a second lift arm section at an outer end of said first lift arm section pivotally mounted to the first lift arm section about a second axis parallel to the first pivot axis, and hydraulic actuators for selectively controlling the movement of the first and second lift arm sections about the first and second pivot axes independently of one another.

5. The self-propelled shredder of claim 4, wherein said lifting fork comprises a pair of tines, said tines extending in fore and aft direction at outer ends of the second lift arm section, a first of said tines being stationarily mounted to an outer end of said second lift arm section, and a second of said tines being mounted outwardly of the first tine, a telescoping frame at an inner end of the fork supporting the second tine for movement of the second tine toward and away from the first tine, and an actuator for slidably moving the second tine relative to the first tine, a space between the tines being unobstructed at a front end to the fork.

6. The self-propelled shredder of claim 5, wherein said tines have projecting elements thereon facing a space between the first and second tines, the elements being of length to permit a bale to slide between the tines when the second tine is moved outwardly from the first tine, and to engage the bale when the second tine is moved toward the first tine with a bale of crop material between the first and second tines.

7. A self-propelled shredder for shredding crop material formed into bales, said self-propelled shredder including a frame, support wheels for supporting the frame and shredder relative to ground for movement, a shredding rotor rotatably mounted adjacent one side of the frame and rotatable about an axis extending in a fore and aft direction relative to a direction of movement, a feeder for feeding a bale of crop material into the shredding rotor, and a conveyor for removing shredded material, a lift fork for lifting bales from the ground to a platform that moves the bales to the shredding rotor, said lift fork being supported on a lift arm assembly having a fork adapted to engage and retain a bale for movement upwardly from the ground, said lift arm assembly having two lift arm sections, the first lift arm section being pivotally mounted to the frame, and the second lift arm section being pivotally mounted to an outer end of the first arm section, said second lift arm section carrying the fork, and hydraulic actuators for moving the first lift arm section about its pivotal mounting to the frame, and for pivotally moving the second lift arm section relative to the first arm section.

8. The self-propelled shredder of claim 7, wherein said lift fork has a pair of fore and aft extending tines, a first tine being mounted at an outer end of the second lift arm section, and a second tine slidably mounted on the fork for movement toward and away from the first tine.

9. The self-propelled shredder of claim 8, wherein the slidable mounting of the second tine comprises a pair of telescoping tubes, and an actuator for moving the second tine relative to the first tine as supported by the telescoping tubes.

10. The self-propelled shredder of claim 7, wherein there is a conveyor for receiving shredded material from the shredding rotor and moving the material longitudinally, and a rotary impeller for receiving material from the conveyor, and a discharge chute on the rotary impeller for directing material that has been shredded outwardly from the frame.

11. The self-propelled shredder of claim 7, wherein said frame mounts a power source, said power source driving a hydraulic pump, and a hydraulic motor for driving the shredding rotor.

12. The self propelled shredder of claim 7 wherein the support wheels are mounted on front and rear axles, said front and rear axles each comprising a base tube and telescoping tubes at each end of the base tube, and a power drive to change the spacing between the support wheels on each of the front and rear axles.

13. The self-propelled shredder of claim 7 wherein the support wheels are mounted on front and rear axles, the front and rear axles each being pivoted to the frame about an axle pivot axis that extends in fore and aft directions, and power cylinders to control the position of the front and rear axles about the axle pivot axis.
